(19) United States
(12) Patent Application Publication
(10) Pub. No.: US 2021/0083543 A1
(43) Pub. Date: Mar. 18, 2021

(54) ELECTRIC WORKING MACHINE AND METHOD OF BUILDING ELECTRIC SYSTEM IN ELECTRIC WORKING MACHINE

(71) Applicant: MAKITA CORPORATION, Anjo-shi, Aichi (JP)

(72) Inventors: Masahiro WATANABE, Anjo-shi (JP); Akira NIWA, Anjo-shi (JP)

(73) Assignee: MAKITA CORPORATION, Anjo-shi, Aichi (JP)

(21) Appl. No.: 16/954,412

(22) PCT Filed: Dec. 19, 2018
(86) PCT No.: PCT/JP2018/046805

§ 371 Date: Jun. 16, 2020

(30) Foreign Application Priority Data
Dec. 19, 2017 (JP) 2017-242567

(51) Int. Cl. H02K 5/08; B25B 23/18; H02K 11/33; H02K 11/215; B25F 5/02; H02K 5/22

(52) U.S. Cl. CPC H02K 5/08; B25B 23/18; H02K 5/225; H02K 11/215; B25F 5/02; H02K 11/33

(57) ABSTRACT

An electric working machine includes a molded member, a motor, a control circuit, and an electric circuit. The molded member includes an insulating material and is molded in one piece. The control circuit is configured to control the motor. The electric circuit is coupled to the control circuit. The electric circuit includes a surface circuit that is integrally arranged on a surface of the molded member.

### CROSS-REFERENCE TO RELATED APPLICATION

This international application claims the benefit of Japanese Patent Application No. 2017-242567, filed on Dec. 19, 2017 in the Japan Patent Office, and the entire disclosure of Japanese Patent Application No. 2017-242567 is incorporated herein by reference.

### TECHNICAL FIELD

The present disclosure relates to an electric working machine.

### BACKGROUND ART

An electric power tool disclosed in Patent Document 1 introduced below includes an LED; the LED and a control unit are connected to each other via lead wires.

### PRIOR ART DOCUMENTS

### Patent Documents

Patent Document 1: Japanese Patent Publication No. 5117244

### SUMMARY OF THE INVENTION

### Problems to be Solved by the Invention

With respect to the aforementioned electric power tool, wiring operation of lead wires may be cumbersome or time consuming, and the lead wires may be easily disconnected due to vibrations of the electric power tool.

Preferably, one aspect of the present disclosure can achieve an efficient installment of an electric circuit in an electric working machine.

### Means for Solving the Problems

In one aspect of the present disclosure, an electric working machine includes a first molded member, a motor, a control circuit, and an electric circuit. The first molded member includes an insulating material and is molded in one piece. The control circuit is configured to control the motor. The electric circuit is coupled to the control circuit. The electric circuit includes a surface circuit that is integrally arranged on a surface of the first molded member.

In the electric working machine configured as above, the first molded member is used to install the electric circuit. More specifically, a part of the electric circuit (which is the surface circuit) is integrally formed on the first molded member. The electric circuit can thus be efficiently installed in the electric working machine.

The whole first molded member may include the insulating material, or the first molded member may include the insulating material and other material different from the insulating material. The insulating material may be any material with insulation properties. For example, the insulating material may include or does not have to include a resin. Such a resin may be, for example, a thermoplastic resin or a thermosetting resin. For example, the insulating material may include or does not have to include a glass. For example, the insulating material may include or does not have to include a rubber. The first molded member may be molded by any method. For example, the first molded member may be molded by injection molding or low temperature and pressure molding. These matters mentioned above in relation to the composition and the molding methods of the first molded member apply to a second molded member which will be mentioned later.

The surface circuit may be disposed only on a surface of the insulating material. A part of the surface circuit may be disposed in an area different from an area on the surface of the first molded member where the insulating material is present.

The surface of the first molded member may include a three dimensionally shaped portion. At least a part of the surface circuit may be located on the three dimensionally shaped portion on the surface of the first molded member.

In the electric working machine configured as above, the three dimensionally shaped portion on the surface of the first molded member is used to mount the surface circuit. Thus, it is possible to install the electric circuit by efficiently utilizing the first molded member.

The electric circuit may include an electronic component provided separately from the surface circuit. The electric circuit may include a lead wire coupling the electronic component to the surface circuit. For example, the lead wire may be a conducting wire coated with an insulation or a conducting wire not coated with an insulation (for example, a nonflexible rod-shaped, plate-shaped, or other three dimensionally shaped conductor).

In the electric working machine configured as above, an arrangement position of the electronic component can be determined very freely while achieving enhancement of efficiency in installing the electric circuit.

The electric circuit may be disposed on the first molded member and include an electronic component coupled to the surface circuit. In other words, the electronic component may be directly disposed on the first molded member without the lead wire.

In the electric working machine configured as above, it is possible to install the electric circuit more efficiently.

The electric working machine may further include a component mounted member. The component mounted member may be arranged so as to contact the surface circuit. The electric circuit may include an electronic component disposed on the component mounted member. The electric circuit may include a connection wiring portion. The connection wiring portion may be disposed on a surface of the component mounted member so as to contact the surface circuit and may be configured to couple the electronic component to the surface circuit.

In the electric working machine configured as above, the surface circuit disposed on the first molded member contacts the connection wiring portion disposed on the component mounted member, which electrically couples the surface circuit to the electronic component. Accordingly, the electronic component can be stably mounted and an arrangement position of the electronic component can be determined very freely while achieving enhancement of efficiency in installing the electric circuit.

The first molded member may include a recess. The recess may include an inner wall. A part of the surface circuit may be located on the inner wall. The component mounted member may include an inset configured to fit into the recess. A part of the connection wiring portion may be disposed on the inset.

In the electric working machine configured as above, the component mounted member can be stably fixed with respect to the first molded member while causing the surface circuit and the connection wiring portion to contact each other.

The electric working machine may further include a second molded member including an insulating material and being molded in one piece. The second molded member may include the component mounted member.

In the electric working machine configured as above, a single electric circuit is provided by a combination of the first molded member and the second molded member. Thus, it is possible to install the electric circuit more efficiently.

The electronic component may include a light emitting element configured to emit (or radiate) light. The electronic component may also include a connector configured to be coupled to a connector situated externally of the electric working machine.

In the electric working machine configured as above, it is possible to efficiently install the electric circuit that causes the light emitting element to emit light or that establishes an electrical connection to an external device via the connector.

The motor may be a brushless motor including a permanent-magnet type rotor. In this case, the first molded member may be placed in a fixed position relative to the brushless motor. The electronic component may include a rotation position detecting device configured to output a signal associated with a rotation position of the rotor. The surface circuit may include a wiring coupled to the rotation position detecting device.

In the electric working machine configured as above, it is possible to efficiently install the rotation position detecting device and the wiring coupled to the rotation position detecting device by means of the first molded member.

The electric working machine may further include a housing. The housing houses the motor, the control circuit, and the electric circuit. The first molded member is a separate member from the housing and may be disposed inside the housing.

In the electric working machine configured as above, it is possible to efficiently install the electric circuit by means of the first molded member disposed inside the housing.

The first molded member may include a case member including a housing space for housing the control circuit. The whole first molded member may be the case member (in other words, the whole case member may be the first molded member). The surface circuit may be disposed on an inner wall of the case member facing the housing space.

In the electric working machine configured as above, it is possible to efficiently couple the control circuit to the electric circuit by means of the case member that houses the control circuit.

The first molded member may include a housing that houses the motor, the control circuit, and the electric circuit. The whole first molded member may be the housing (in other words, the whole housing may be the first molded member).

In the electric working machine configured as above, the electric circuit is installed by means of a surface of the housing. Accordingly, it is possible to efficiently install the electric circuit without using additional molded members other than the housing or with a reduced amount of additional molded member.

The first molded member may include an opening exposed externally from the electric working machine. The electric working machine may further include an opening attachment attached to the opening. The opening attachment may be configured to be removable from the opening. The surface circuit may include two conductors disposed at the opening separately from each other. The opening attachment may include a conductive portion. The conductive portion is configured to be coupled to the two conductors and electrically couple the two conductors to each other in response to the opening attachment being attached to the opening.

In the electric working machine configured as above, the two conductors are electrically coupled to each other if the opening attachment is attached to the opening but are not electrically coupled to each other if the opening attachment is removed from the opening. Thus, it is possible for the control circuit to easily determine whether the opening attachment is appropriately attached to the opening based on whether the two conductors are electrically coupled to each other, for example.

The first molded member may include a housing that houses the motor, the control circuit, and the electric circuit, and includes the opening. The opening attachment may be configured to cover the opening.

In the electric working machine configured as above, it is possible for the control circuit to easily determine whether the opening attachment is appropriately attached to the opening of the housing based on whether the two conductors are electrically coupled to each other, for example. In this case, various controls by the control circuit depending on results of the determination are possible.

The surface circuit may include two wirings disposed along a given wiring path. The first molded member may include a protruding wall. The protruding wall stands between the two wirings and extends along the given wiring path. The given wiring path may be laid in a given wiring direction.

In the electric working machine configured as above, the protruding wall inhibits short-circuit of the two wirings. It is accordingly possible to enhance insulation properties of the two wirings.

The first molded member may include an injection-molded member. The injection-molded member is an integrally molded member made by injecting and curing a liquid member in a die. The injection-molded member may include any materials. The injection-molded member may include, for example, a thermoplastic resin, or a thermosetting resin. The whole first molded member may be the injection-molded member, or a part of the first molded member may be the injection-molded member. In the first molded member, for example, the whole insulating material may form the injection-molded member and a material other than the insulating material may form a member different from the injection-molded member. Also, for example, a part of the insulating material may form the injection-molded member and the rest of the insulating material may form a member different from the injection-molded member. The aforementioned second molded member may include the injection-molded member similarly to the first molded member.

Another aspect of the present disclosure is a method of building an electric system in an electric working machine. The method includes disposing a control circuit in the electric working machine, the control circuit being configured to control a motor; disposing a molded member in the electric working machine, the molded member including an insulating material and being molded in one piece, and the molded member having a surface with a surface circuit integrally arranged thereon; and coupling the surface circuit and the control circuit to each other.

Such a method can exert effects similar to the effects of the aforementioned electric working machine.

Yet another aspect of the present disclosure is a method of building an electric system in an electric working machine, wherein disposing a control circuit in the electric working machine, the control circuit being configured to control a motor; disposing a molded member in the electric working machine, the molded member including an insulating material and being molded in one piece, the molded member having a surface with a surface circuit integrally arranged thereon, and the surface circuit being coupled to or being configured to be coupled to the control circuit.

Such a method can exert effects similar to the effects of the electric working machine.

### BRIEF DESCRIPTION OF THE DRAWINGS

FIG. 1 is a side view showing inside of an electric working machine in an embodiment.

FIG. 2 is a sectional view showing a partial area of an inner surface of a half housing where a first surface circuit is arranged.

FIG. 3 is a sectional view showing another arrangement example of the first surface circuit on the inner surface of the half housing.

FIG. 4 is a sectional view showing yet another arrangement example of the first surface circuit on the inner surface of the half housing.

FIG. 5 is an explanatory diagram showing a structure of a rear end surface of a housing and a front end surface of a rear cover.

FIG. 6 is an explanatory diagram showing a state of connection of Hall elements and a controller.

FIG. 7 is an electric circuit diagram of the electric working machine in the embodiment.

FIG. 8 is a flowchart showing a part of a motor control process in the embodiment.

FIG. 9 is a flowchart showing the rest of the motor control process in the embodiment.

FIG. 10 is an explanatory diagram showing an installment example for an LED illuminator.

FIG. 11 is an explanatory diagram showing another installment example for the LED illuminator.

FIG. 12 is a sectional view taken along line XII-XII in FIG. 11.

FIG. 13 is an explanatory diagram showing another installment example for the LED illuminator.

FIG. 14 is an explanatory diagram showing an installment example of an electronic component in a controller case.

FIG. 15 is an electric circuit diagram showing an example of another electric working machine.

### EXPLANATION OF REFERENCE NUMERALS

1, 200 . . . electric working machine; 2, 100, 210 . . . housing; 3 . . . battery pack; 3a . . . battery; 4, 5 . . . half housing; 4a . . . inner surface; 6 . . . rear opening; 7 . . . rear cover; 10 . . . motor; 10a . . . rotor; 11 . . . hammer case; 13 . . . hammer case cover; 14 . . . insulator; 16, 17, 18 . . . Hall element; 20, 120 . . . controller case; 24, 121 . . . controller; 26 . . . control circuit; 31 . . . first electrode; 32 . . . second electrode; 33 . . . connection conductor; 34 . . . first lead wire; 35 . . . second lead wire; 38 . . . third lead wire; 39 . . . fourth lead wire; 41 . . . LED illuminator; 42 . . . first surface circuit; 46, 47, 48 . . . protruding wall; 49 . . . groove; 50 . . . resin wiring member; 51 . . . green LED; 52 . . . red LED; 53 . . . second surface circuit; 54 . . . third surface circuit; 56 . . . USB connector; 57 . . . fourth surface circuit; 71 . . . fifth surface circuit; 72 . . . sixth surface circuit; 73 . . . seventh surface circuit; 101 . . . recess; 102 . . . main body surface circuit; 110 . . . LED case; 112 . . . inset; 116 . . . case surface circuit; 120a . . . housing space; 131, 132, 133, 166 . . . surface circuit; 136 . . . LED; 137 . . . switch; 138 . . . electronic component; 160 . . . hammer case cover; 160a . . . inner surface; 161 . . . groove; 166a . . . trace; 201, 211 . . . terminal block; 216 . . . first resin wiring member; 217 . . . second resin wiring member; 221, 222 . . . surface circuit; 221a, 222a, 421 . . . first trace; 221b, 222b, 422 . . . second trace.

### MODE FOR CARRYING OUT THE INVENTION

Hereinafter, example embodiments of the present disclosure will be explained with reference to the drawings.

### 1. Embodiment

### (1-1) Configuration of Electric Working Machine

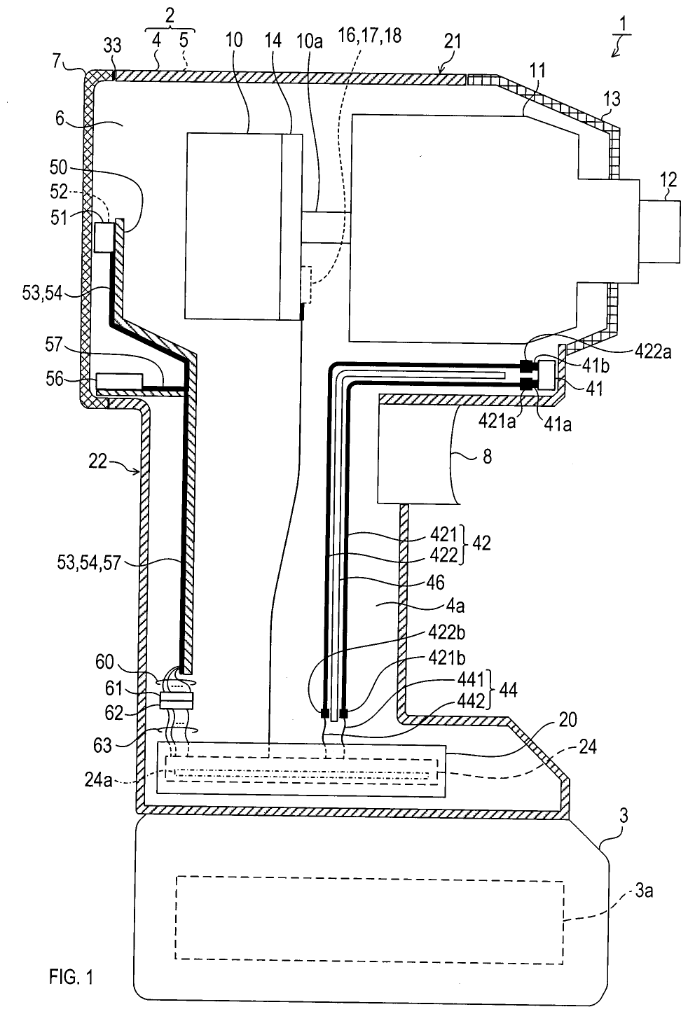

An electric working machine 1 in the present embodiment shown in FIG. 1 is configured as a rechargeable impact driver for example. The electric working machine 1 includes a housing 2. The housing 2 includes two half housings 4, 5 dividing the housing 2 in right and left sides. The housing 2 is formed by combining these half housings 4, 5. FIG. 1 shows the electric working machine 1 with the half housing 5 on the right side removed.

The half housings 4, 5 of the present embodiment are, for example, molded members integrally molded with an insulating material (in other words, integrally molded items). More specifically, the half housings 4, 5 may be, for example, injection-molded members formed by injection molding of an insulating material including a resin. The half housings 4, 5 are formed three dimensionally. The half housings 4, 5 include three dimensional shapes including curved surfaces.

The housing 2 includes a main body 21 and a grip 22. The grip 22 extends downwards from the main body 21. On a lower end of the grip 22, which is a lower end of the housing 2, a battery pack 3 is attached. The battery pack 3 is configured to be attachable to and removable from the housing 2.

The battery pack 3 contains a battery 3a inside. Electric power of the battery 3a is supplied to the housing 2. In the present embodiment, the battery 3a is, for example, a rechargeable battery that can be charged and discharged repeatedly. For example, the battery 3a may be a lithium ion rechargeable battery.

The electric working machine 1 has its front on the right side of FIG. 1, has its rear on the left side of FIG. 1, has its upper side on the upper side of FIG. 1, and has its lower side on the lower side of FIG. 1. With respect to the electric working machine 1, a right direction perpendicularly points out from the surface of the drawing; a left direction perpendicularly points into the drawing surface.

The housing 2 houses a motor 10, a hammer case 11, a controller case 20, a resin wiring member 50, and various electric circuits. The controller case 20 includes a housing space inside. The housing space houses a controller 24. The controller 24 is supplied with the electric power from the battery 3a.

The various electric circuits include a first electric circuit. The first electric circuit includes an LED illuminator 41, and a circuit for coupling the LED illuminator 41 to the controller 24. The LED illuminator 41 is disposed in a front end of the main body 21 and emits (or radiates) light ahead of the electric working machine 1.

The various electric circuits also include a second electric circuit. The second electric circuit includes a green LED 51, and a circuit for coupling the green LED 51 to the controller 24. The various electric circuits also include a third electric circuit. The third electric circuit includes a red LED 52, and a circuit for coupling the red LED 52 to the controller 24.

The green LED 51 and the red LED 52 are disposed in a rear end of the main body 21 and emits (or radiates) light behind the electric working machine 1. The green LED 51 emits (or radiates) green light; the red LED 52 emits (or radiates) red light.

The various electric circuits also include a fourth electric circuit. The fourth electric circuit includes a USB connector 56, and a circuit for coupling the USB connector 56 to the controller 24. Another USB connector, which is not shown in the drawings, is attached to and removed from the USB connector 56. The USB connector 56 is used in data communication with an external device different from the electric working machine 1 in accordance with Universal Serial Bus (USB) standards for data communication.

The green LED 51, the red LED 52, and the USB connector 56 are mounted on a surface of the resin wiring member 50.

The various electric circuits also include a fifth electric circuit. The fifth electric circuit includes three Hall elements 16, 17, 18, and a circuit for coupling the Hall elements 16, 17, 18 to the controller 24.

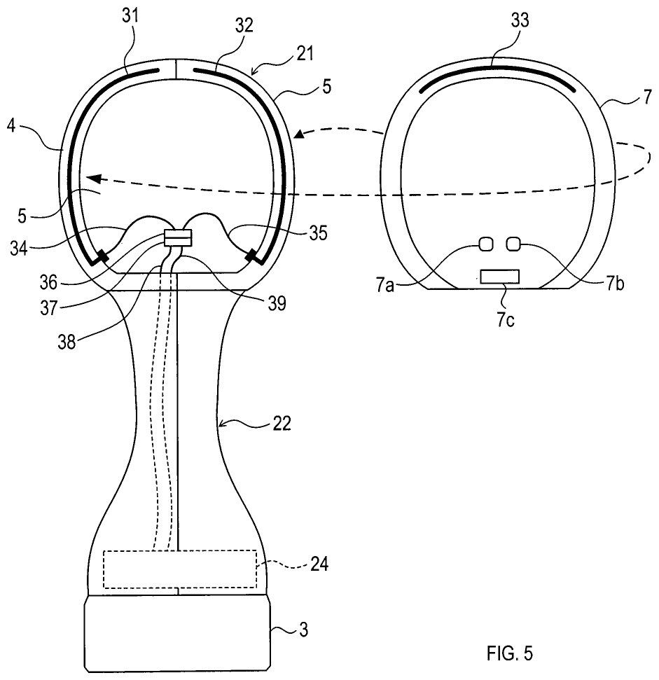

The various electric circuits also include a sixth electric circuit. The sixth electric circuit includes a connection conductor 33, a first electrode 31 (see FIG. 5), a second electrode 32 (see FIG. 5), and a circuit for coupling these two electrodes 31, 32 to the controller 24.

The resin wiring member 50 is, for example, a molded member formed by integral molding of an insulating material (in other words, integrally molded item). More specifically, the resin wiring member 50 may be an injection-molded member formed by injection molding of an insulating material including a resin. The resin wiring member 50 is formed three dimensionally in one piece. The resin wiring member 50 includes a three dimensional shape including a curved surface. The resin wiring member 50 is disposed inside the housing 2 but separately from the housing 2. In other words, the resin wiring member 50 and the housing 2 are not integrally molded but are individually molded. Nevertheless, the resin wiring member 50 may be integrally molded with, for example, the left half housing 4.

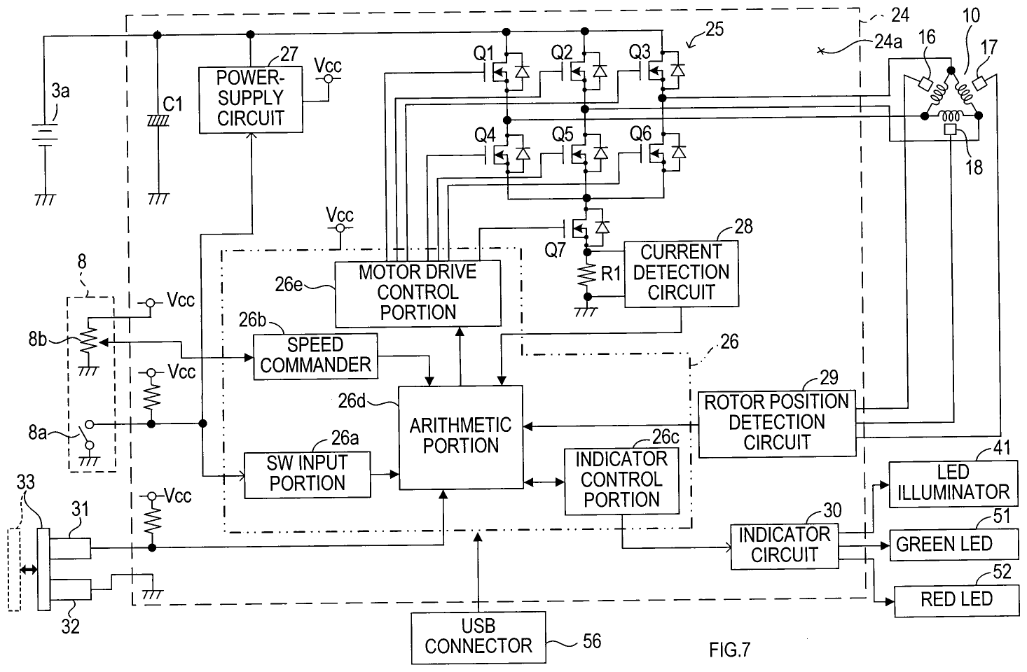

The motor 10 is, for example, a brushless motor including a stator and a permanent-magnet type rotor 10a. The stator includes an armature winding of each of U, V, W phases (see FIG. 7).

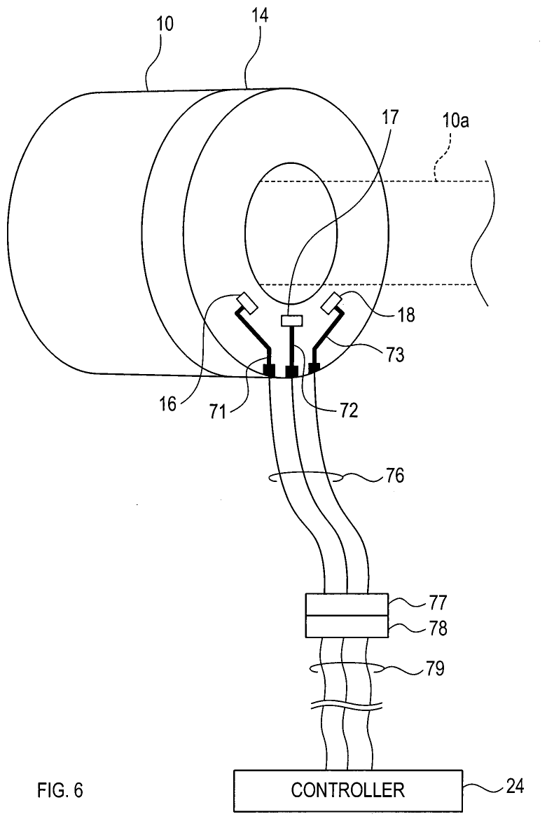

On a front end of the motor 10, an insulator 14 is disposed. Both of the motor 10 and the insulator 14 have approximately cylindrical shapes as shown in FIG. 6. The insulator 14 has a through hole for the rotor 10a to pass through.

The insulator 14 is fixed to the motor 10. On a front surface of the insulator 14, the three Hall elements 16, 17, 18 are disposed. The insulator 14 is, for example, a molded member formed by integral molding of an insulating material (in other words, integrally molded item). More specifically, the insulator 14 may be an injection-molded member formed by injection molding of an insulting material including a resin. The insulator 14 is formed three dimensionally in one piece.

As shown in FIG. 6, the Hall elements 16, 17, 18 are mounted on the front surface of the insulator 14 about a rotational axis of the rotor 10a at intervals corresponding to 120 degrees in electrical angle. Each of the Hall elements 16, 17, 18 outputs a rotation detection signal associated with a rotation position of the rotor 10a. As shown in FIG. 1 (more specifically in FIG. 6), each of the Hall elements 16, 17, 18 is electrically coupled to the controller 24.

The hammer case 11 is disposed in front of the motor 10. In front of the hammer case 11, a chuck sleeve 12 is disposed. A rotation of the motor 10, which is a rotation of the rotor 10a, is transmitted to the shuck sleeve 12 via a deceleration mechanism and a hammering mechanism inside the hammer case 11, which are not shown in the drawings. Various tool bits, which are not shown in the drawings, such as a driver bit and a socket bit, are attached to the chuck sleeve 12.

The hammering mechanism housed in the hammer case 11 includes, for example, a spindle, a hammer, and an anvil. The spindle is rotated by a rotational driving force of the rotor 10a transmitted via the deceleration mechanism. The hammer rotates with the spindle and is movable in axial directions. The anvil is disposed in front of the hammer The chuck sleeve 12 is attached to a leading end of the anvil.

In the hammering mechanism, the rotation of the spindle in response to the rotation of the motor 10 causes the anvil to rotate via the hammer, which then causes the chuck sleeve 12 (and thus the tool bit) to rotate. As a load on the anvil increases due to an advancement of work (for example, screw tightening) by the tool bit, the hammer applies intermittent hammerings on the anvil. This hammerings enables additional tightening of the screw, for example.

A front part of the hammer case 11 is covered with a hammer case cover 13. More specifically, a front part of the housing 2 has an opening, which is covered with the hammer case cover 13. The hammer case 11 is exposed externally from the housing 2 by removing the hammer case cover 13 from the housing 2. The opening of the housing 2 is closed with the hammer case cover 13 by attaching the hammer case cover 13 onto the housing 2; the hammer case 11 is thus covered with the hammer case cover 13 except for a frontal part of the hammer case 11.

The grip 22 is held by a user of the electric working machine 1. A trigger 8 is disposed in the grip 22. The user can manipulate the trigger 8 by pulling the trigger 8 with his finger while holding the grip 22. The trigger 8 includes a trigger switch 8a and a manipulation amount detector 8b (see FIG. 7 for both), which will be mentioned later.

The housing 2 includes a rear opening 6, which opens to the rear. A rear cover 7 for covering the rear opening 6 is attached to the rear opening 6. The rear cover 7 is attachable to and removable from the housing 2. In the present embodiment, the rear cover 7 is, for example, a molded member formed by integral molding of an insulating material (in other words, integrally molded item). More specifically, the rear cover 7 may be an injection-molded member formed by injection molding of an insulating material including a resin. The rear cover 7 is formed three dimensionally in one piece.

### (1-2) Explanation of Installment of Various Electric Circuits

### (1-2-1) First Electric Circuit Including LED Illuminator 41

The first electric circuit includes the LED illuminator 41 and a first surface circuit 42. The LED illuminator 41 is coupled to the controller 24 mainly via the first surface circuit 42 and an illuminator harness 44. The LED illuminator 41 includes a first electrode 41a and a second electrode 41b.

The first surface circuit 42 includes a first trace 421 and a second trace 422. The first trace 421 and the second trace 422 are disposed inside the housing 2. More specifically, the first trace 421 and the second trace 422 are integrally disposed in an area on an inner surface 4a of the half housing 4 (in other words, closely fitted to the inner surface 4a); the area includes the three dimensionally shaped portion.

The first trace 421 and the second trace 422 are laid parallelly along a given wiring path. More specifically, the first trace 421 and the second trace 422 are laid from a rear side of the LED illuminator 41 towards the rear of the electric working machine 1, bent downwards, and laid to a neighborhood of the controller case 20. The first trace 421 and the second trace 422 do not have to be parallel to each other. The first surface circuit 42 may include, for example, a part where the first trace 421 and the second trace 422 are parallelly laid and a part where they are not parallelly laid. Alternatively, for example, the first surface circuit 42 may have the first trace 421 and the second trace 422 with completely no parallelly laid parts.

On a first end of the first trace 421, a first electrode 421a is disposed. On a second end of the first trace 421, a second electrode 421b is disposed. On a first end of the second trace 422, a first electrode 422a is disposed. On a second end of the second trace 422, a second electrode 422b is disposed.

The first electrode 41a of the LED illuminator 41 contacts the first electrode 421a on the first trace 421. The second electrode 41b of the LED illuminator 41 contacts the first electrode 422a on the second trace 422. These contacts cause the first electrode 41a and the first electrode 421a to be electrically coupled to each other, and cause the second electrode 41b and the second electrode 422b to be electrically coupled to each other.

The harness 44 includes two lead wires 441, 442. A first end of the lead wire 441 is coupled to the second electrode 421b on the first trace 421. A second end of the lead wire 441 is coupled to the controller 24. A first end of the lead wire 442 is coupled to the second electrode 422b on the second trace 422. A second end of the lead wire 442 is coupled to the controller 24.

Various methods may be taken to integrally dispose the first surface circuit 42 on the inner surface 4a of the half housing 4.

In the present embodiment, the half housing 4 is, for example, one kind of Molded Interconnect Device (MID). The MID is a resin molded item with an electric circuit, including wirings and electrodes, formed thereon. Various methods of forming an electric circuit are available for the MID; for example, Laser Direct Structuring (LDS) method is known. In the half housing 4 in the present embodiment, the first surface circuit 42 may be integrally formed on the inner surface 4a by the LDS method for example.

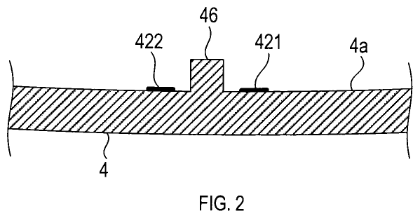

As shown in FIG. 1 and FIG. 2, a protruding wall 46 stands between the first trace 421 and the second trace 422. The protruding wall 46 is a part of the half housing 4. The protruding wall 46 is integrally molded with the half housing 4 when molding the half housing 4 by the injection molding. The main purpose of the protruding wall 46 is to enhance the insulation properties of the first trace 421 and the second trace 422 to thereby reduce a chance of short-circuit between the first trace 421 and the second trace 422.

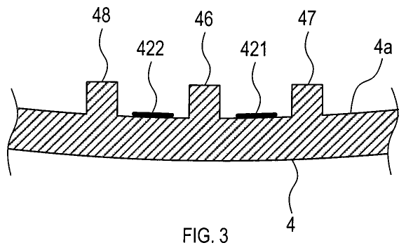

As shown in FIG. 3, for example, a protruding wall 47 may additionally be disposed on another side of the first trace 421 opposite the side where the protruding wall 46 stands. Also, a protruding wall 48 may additionally be disposed on another side of the second trace 422 opposite the side where the protruding wall 46 stands. In FIG. 3, the inner surface 4a of the half housing 4 and the protruding walls 46, 47 form a grooved area. The first trace 421 is laid inside the grooved area. This enhances the insulation properties of the first trace 421. Additionally, for example, applications of insulation coatings and desiccants on the first trace 421 are made easier. The similar effects can be achieved on the second trace 422 in FIG. 3.

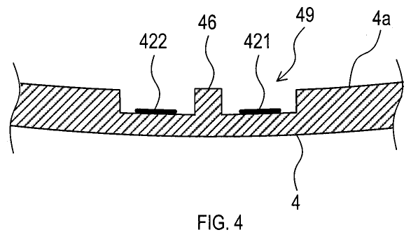

Moreover, as shown in FIG. 4, for example, the inner surface 4a may include a groove 49. The traces 421, 422 may be laid on a bottom surface of the groove 49. In this case, as shown in FIG. 4, the protruding wall 46 may be disposed between the traces 421 and 422 on the bottom surface of the groove 49. The protruding wall 46 may also be omitted in FIG. 2 to FIG. 4.

### (1-2-2) Second Electric Circuit, Third Electric Circuit, and Fourth Electric Circuit Wired by Using Resin Wiring Member 50

The second electric circuit includes the green LED 51 and a second surface circuit 53. The third electric circuit includes the red LED 52 and a third surface circuit 54. The fourth electric circuit includes the USB connector 56 and a fourth surface circuit 57. As shown in FIG. 1, the green LED 51, the red LED 52, and the USB connector 56 are mounted on the resin wiring member 50. On a surface of the resin wiring member 50, the second surface circuit 53, the third surface circuit 54, and the fourth surface circuit 57 are disposed integrally with the resin wiring member 50.

The green LED 51 is coupled to the controller 24 mainly via the second surface circuit 53, a first rear harness 60, and a second rear harness 63. The red LED 52 is coupled to the controller 24 mainly via the third surface circuit 54, the first rear harness 60, and the second rear harness 63. The USB connector 56 is coupled to the controller 24 mainly via the fourth surface circuit 57, the first rear harness 60, and the second rear harness 63.

The resin wiring member 50 is a three dimensionally shaped injection-molded member. Each of the surface circuits 53, 54, 57 is also formed three dimensionally. Likewise the housing 2, the resin wiring member 50 is one kind of the MID. Each of the surface circuits 53, 54, 57 is formed on the resin wiring member 50 by, for example, the LDS method.

The second surface circuit 53 includes, for example, two first traces. First ends of the first traces are coupled to the green LED 51. Second ends of the first traces are coupled to the first rear harness 60. The first rear harness includes two or more lead wires. First ends of two lead wires among these lead wires are coupled to the second ends of the first traces.

The third surface circuit 54 includes, for example, two second traces. First ends of the second traces are coupled to the red LED 52. Second ends of the second traces are coupled to first ends of another two lead wires among the lead wires of the first rear harness 60.

The fourth surface circuit 57 includes, for example, five third traces. First ends of the third traces are coupled to the USB connector 56. Second ends of the third traces are coupled to first ends of another five lead wires among the lead wires of the first rear harness 60.

A second end of the first rear harness 60 is coupled to a first connector 61. The first connector 61 is coupled to a second connector 62. A first end of the second rear harness 63 is coupled to the second connector 62. The second rear harness 63 includes, for example, the same number of lead wires as the lead wires of the first rear harness 60. Each of the lead wires of the second rear harness 63 is coupled to one corresponding lead wire of the first rear harness 60. Another end of the second rear harness 63 is coupled to the controller 24.

### (1-2-3) Sixth Electric Circuit with Function to Detect Whether Rear Cover 7 is Appropriately Attached

As shown in FIG. 5, the sixth electric circuit includes a first electrode 31, a second electrode 32, and a connection conductor 33. The first electrode 31 is disposed on a rear end surface of the half housing 4; the second electrode 32 is disposed on a rear end surface of the half housing 5. The first electrode 31 and the second electrode 32 are disposed in the housing 2 separately from each other (in other words, electrically insulated from each other).

A connection conductor 33 is disposed on a front end surface of the rear cover 7, which is configured to face the rear end surfaces of the half housings 4, 5. As a result of an appropriate attachment of the rear cover 7 to the housing 2, the first electrode 31 and the second electrode 32 contact the connection conductor 33, which then electrically couples the first electrode 31 and the second electrode 32 to each other via the connection conductor 33.

The first electrode 31 is disposed on the rear end surface of the half housing 4 integrally with the half housing 4. More specifically, the first electrode 31 is one example of the surface circuit in the present disclosure, and formed on the rear end surface of the half housing 4 by, for example, the LDS method.

The second electrode 32 is also one example of the surface circuit in the present disclosure, and formed on the rear end surface of the half housing 5 by, for example, the LDS method likewise the first electrode 31.

The connection conductor 33 on the rear cover 7 is also one example of the surface circuit in the present disclosure, and formed on the front end surface of the rear cover 7 by, for example, the LDS method.

The first electrode 31 has its first end open and its second end coupled to the first connector 36 via a first lead wire 34. The second electrode 32 has its first end open and its second end coupled to the first connector 36 via a second lead wire 35. The first connector 36 is coupled to a second connector 37. The second connector 37 is coupled to a third lead wire 38 and a fourth lead wire 39.

The first lead wire 34 is coupled to the third lead wire 38 via each of the connectors 36, 37. In other words, the first electrode 31 is coupled to the controller 24 via first the lead wire 34, the two connectors 36, 37, and the third lead wire 38.

The second lead wire 35 is coupled to the fourth lead wire 39 via each of the connectors 36, 37. In other words, the second electrode 32 is coupled to the controller 24 via the second lead wire 35, the two connectors 36, 37, and the fourth lead wire 39.

As shown in FIG. 5, the rear cover 7 includes LED openings 7a, 7b and a connector opening 7c. The light radiated from the green LED 51 is radiated out of the electric working machine 1 through an LED opening 7a. The light radiated from the red LED 52 is radiated out of the electric working machine 1 through an LED opening 7b. The USB connector 56 is exposed externally from the electric working machine through the connector opening 7c.

### (1-2-4) Fifth Electric Circuit Including Hall Elements 16, 17, 18

As shown in FIG. 6, the fifth electric circuit includes the Hall elements 16, 17, 18, a fifth surface circuit 71, a sixth surface circuit 72, and a seventh surface circuit 73. As shown in FIG. 6, the Hall elements 16, 17, 18 are mounted on the surface of the insulator 14. On the surface of the insulator 14, the fifth surface circuit 71, the sixth surface circuit 72, and the seventh surface circuit 73 are integrally disposed.

Likewise the housing 2, the insulator 14 is, for example, one kind of the MID, and includes each of the surface circuits 71, 72, 73 thereon by, for example, the LDS method.

The fifth surface circuit 71 is laid on the surface of the insulator 14 from the Hall element 16 to an end of the surface of the insulator 14. A first end of the fifth surface circuit 71 is coupled to the Hall element 16; a second end of the fifth surface circuit 71 is coupled to a first end of a first signal harness 76. The fifth surface circuit 71 includes at least one trace.

The sixth surface circuit 72 and the seventh surface circuit 73 are configured basically in a similar manner to the fifth surface circuit 71, each including at least one trace.

The sixth surface circuit 72 is laid on the surface of the insulator 14 from the Hall element 17 to an end of the surface of the insulator 14. A first end of the sixth surface circuit 72 is coupled to the Hall element 17; a second end of the sixth surface circuit 72 is coupled to the first end of the first signal harness 76.

The seventh surface circuit 73 is laid on the surface of the insulator 14 from the Hall element 18 to an end of the surface of the insulator 14. A first end of the seventh surface circuit 73 is coupled to the Hall element 18; a second end of the seventh surface circuit 73 is coupled to the first end of the first signal harness 76.

The first signal harness 76 includes lead wires for coupling the Hall elements 16, 17, 18 to the controller 24. A second end of the first signal harness 76 is coupled to a first connector 77. The first connector 77 is coupled to a second connector 78. The second connector 78 is coupled to a first end of a second signal harness 79. The second signal harness 79 include, for example, the same number of lead wires as the lead wires of the first signal harness 76; each lead wire of the second signal harness 79 is coupled to a corresponding lead wire among the lead wires of the first signal harness 76. A second end of the second signal harness 79 is coupled to the controller 24.

### (1-3) Electrical Configuration of Electric Working Machine 1

An electrical configuration of the electric working machine 1 will be explained specifically with reference to FIG. 7. As shown in FIG. 7, in the electric working machine 1, the controller 24 is coupled to the battery 3a, the trigger 8, the motor 10, the Hall elements 16, 17, 18, the first electrode 31, the second electrode 32, the LED illuminator 41, the green LED 51, the red LED 52, and the USB connector 56. The battery 3a is coupled to the controller 24 when the battery pack 3 is attached to the housing 2.

The trigger 8 includes the trigger switch 8a and the manipulation amount detector 8b. The trigger switch 8a is turned on when the trigger 8 is operated by a pulling motion. A first end of the trigger switch 8a is coupled to a supply line of a power supply voltage Vcc via a resistor (in other words, the first end of the trigger switch 8a is pulled up to the power supply voltage Vcc) and is also coupled to a control circuit 26 and a power-supply circuit 27. A second end of the trigger switch 8a is coupled to a ground line.

The manipulation amount detector 8b outputs a signal in accordance with the pulled amount of the trigger 8 (in other words, amount of manipulation on the trigger 8). In the present embodiment, the manipulation amount detector 8b includes a variable resistor, a resistance value of which changes in accordance with the pulled amount of the trigger 8, and is configured to output a signal having a voltage value in accordance with the resistance value of the variable resistor.

In the controller 24, the first electrode 31 is coupled to the supply line of the power supply voltage Vcc via a resistor (in other words, the first electrode 31 is pulled up to the power supply voltage Vcc) and is also coupled to the control circuit 26. The second electrode 32 is coupled to the ground line in the controller 24.

The controller 24 includes a drive circuit 25, the control circuit 26, the power-supply circuit 27, a current detection circuit 28, a rotor position detection circuit 29, and an indicator circuit 30.

The drive circuit 25 is provided with power supply from the battery 3a and supplies each phase winding of the motor 10 with three-phase current. In the present embodiment, the drive circuit 25 includes a three-phase full-bridge circuit. More specifically, the drive circuit 25 in the present embodiment includes six switching-elements Q1 to Q6. Each of the switching-elements Q1 to Q6 is, for example, a metal oxide semiconductor field-effect transistor (MOSFET) in the present embodiment.

In the drive circuit 25, each of the switching-elements Q1 to Q3 is a so-called high-side switch and is coupled between a respective terminal U, V, W of the motor 10 and a positive electrode of the battery 3a.

Each of the switching-elements Q4 to Q6 is a so-called low-side switch and is coupled between the respective terminal U, V, W of the motor 10 and a negative electrode of the battery 3a.

A first power supply path, which is from the positive electrode of the battery 3a to the drive circuit 25, is provided with a capacitor C1 for inhibiting fluctuations in battery voltage.

A second power supply path, which is from the drive circuit 25 to the negative electrode of the battery 3a, includes a switching-element Q7 and a resistor R1. Turning on of the switching-element Q7 completes the second power supply path; turning off of the switching-element Q7 interrupts the second power supply path. The current detection circuit 28 outputs a voltage across the resistor R1 to the control circuit 26 as a current detection signal.

The rotor position detection circuit 29 detects a rotation position of the motor 10 based on signals from the Hall elements 16, 17, 18. The rotor position detection circuit 29 outputs a signal corresponding to the detected rotation position to the control circuit 26.

The indicator circuit 30 turns on, blinks, or turns off the LED illuminator 41, the green LED 51, and the red LED 52 in accordance with a command from the control circuit 26.

The power-supply circuit 27 supplies power to parts in the controller 24. More specifically, the power-supply circuit 27 generates the power supply voltage Vcc with a constant voltage value from the electric power input from the battery 3a. The power supply voltage Vcc generated in the power-supply circuit 27 is supplied to the parts in the controller 24 including the control circuit 26 and the indicator circuit 30.

The controller includes a board 24a. The board 24a is where the drive circuit 25, the control circuit 26, the power-supply circuit 27, the current detection circuit 28, the rotor position detection circuit 29, and the indicator circuit 30 are mounted. The board 24a is, for example, a paper phenolic board. The board 24a does not have to be a paper phenolic board. The board 24a may be, for example, a glass epoxy board. The board 24a may be a rigid board that has no pliability and thus is not flexible, or may be a flexible board with pliability.

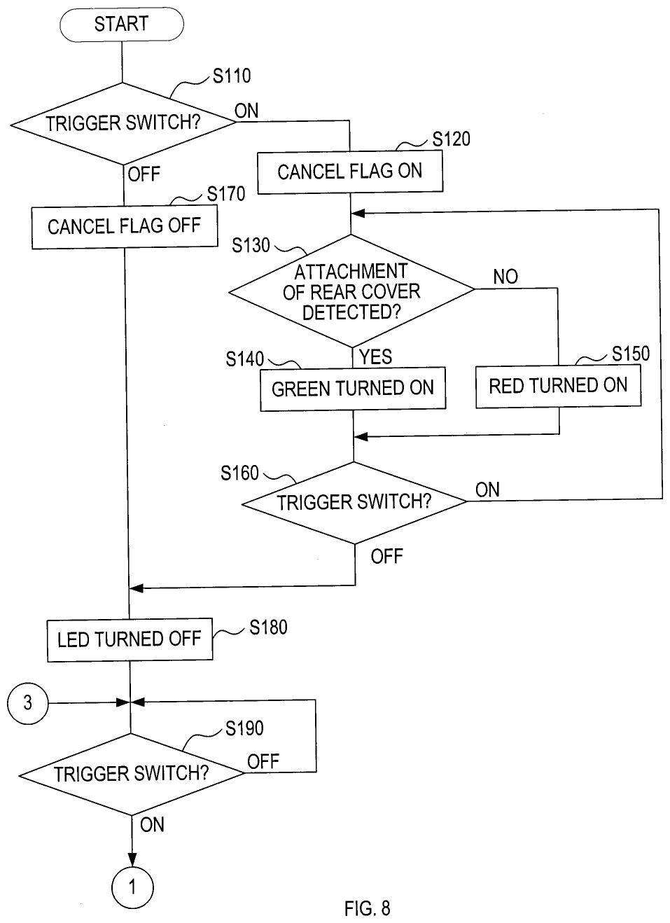

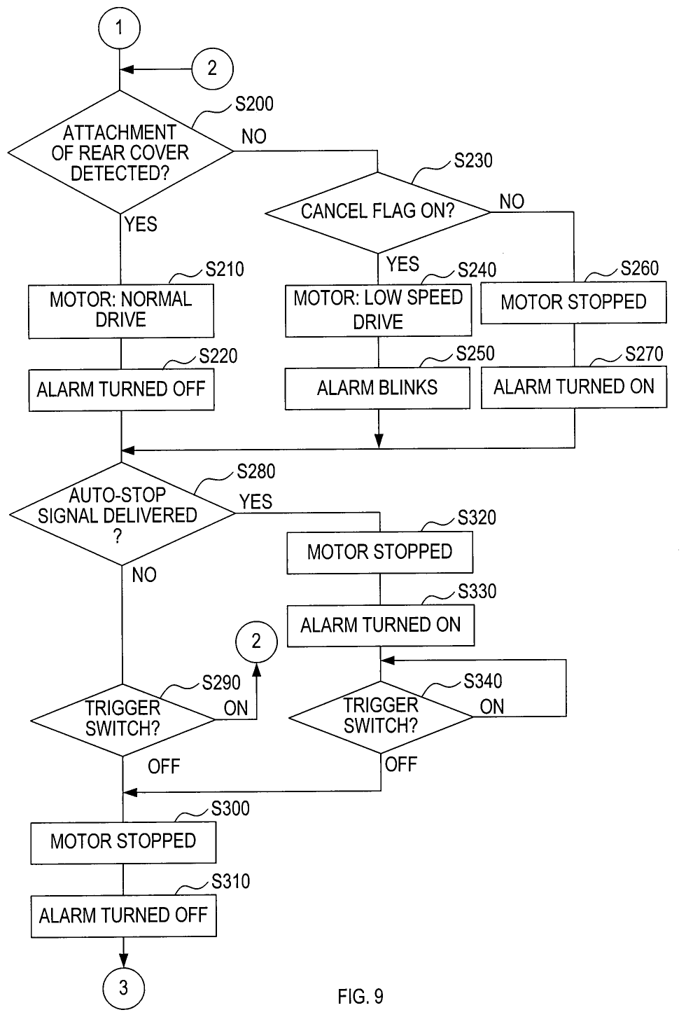

The control circuit 26 includes a microcomputer including a CPU and memory unit which are not shown in the drawings. The memory unit includes various semiconductor memories such as a RAM, a ROM, and a non-volatile memory where data can be rewritten. The memory unit stores various programs and data the CPU reads and executes to achieve various functions. The programs stored in the memory unit include a program of the motor control process shown in FIG. 8 and FIG. 9, which will be explained later.

These various functions may be partially or entirely implemented in the control circuit 26 in a form of a hardware, made from a combination of components such as a logic circuit and an analog circuit, instead of or in addition to a software. It is merely an example that the control circuit 26 includes a microcomputer; the control circuit 26 may take various other forms that allows implementation of the functions of the control circuit 26.

In response to executions of the various programs by the CPU, the control circuit 26 functions as an SW input portion 26a, a speed commander 26b, an indicator control portion 26c, an arithmetic portion 26d, and a motor drive control portion 26e.

The SW input portion 26a detects whether the trigger switch 8a is turned on or off and outputs the detection result to the arithmetic portion 26d.

The speed commander 26b detects the amount of manipulation on the trigger 8 based on the input signal from the manipulation amount detector 8b and outputs the detected amount of manipulation to the arithmetic portion 26d as a speed command for motor drive.

The indicator control portion 26c turns on, blinks, or turns off each of the LED 41, 51, 52 via the indicator circuit 30 in accordance with a command from the arithmetic portion 26d.

The arithmetic portion 26d calculates a rotational speed of the motor 10 based on the detection signal from the rotor position detection circuit 29. The arithmetic portion 26d then generates a PWM signal based on the calculated rotational speed and the speed command (in other words, the amount of manipulation on the trigger 8) delivered from the speed commander 26d.

The arithmetic portion 26d monitors electric current that flows through the motor 10 based on the detection signal delivered from the current detection circuit 28, and commands the motor drive control portion 26e to stop or reduce the rotation of the motor 10 in response to an instance of overcurrent in the motor 10.

The motor drive control portion 26e individually turns on or off the switching-elements Q1 to Q6 in the drive circuit 25 in accordance with the PWM signal generated in the arithmetic portion 26d, and thereby supplies electric current to each phase winding of the motor 10 and rotates the motor 10.

The control circuit 26 also controls data communication conducted via the USB connector 56.

### (1-4) Motor Control Process

With reference to FIG. 8 and FIG. 9, the motor control process executed in the control circuit 26 (executed specifically by the CPU, in other words by the arithmetic portion 26d) will be explained next. In response to initiation of the control circuit 26, the control circuit 26 executes the motor control process. Subsequent to the initiation of the motor control process, the control circuit 26 determines, in S110, whether the trigger switch 8a is turned on or off.

If the trigger switch 8a is turned on, then a cancel flag is set to ON in S120.

In S130, the control circuit 26 determines whether an attachment of the rear cover 7 is detected. More specifically, the control circuit 26 determines whether the first electrode 31 and the second electrode 32 are electrically coupled to each other based on the voltage of the first electrode 31 delivered to the control circuit 26.

If the attachment of the rear cover 7 is detected by establishing that the first electrode 31 and the second electrode 32 are electrically coupled to each other, the control circuit 26 turns on the green LED 51 in S140. If the attachment of the rear cover 7 is not detected by establishing that the first electrode 31 and the second electrode 32 are not electrically coupled to each other, the control circuit 26 turns on the red LED 52 in S150.

In S160, the control circuit 26 determines whether the trigger switch 8a is turned on or off. If the trigger switch 8a is turned on, the process proceeds to S130. If the trigger switch 8a is turned off, the process proceeds to S180.

In S110, if the trigger switch 8a is turned off, then the control circuit 26 sets the cancel flag to OFF in S170 and proceeds the process to S180.

In S180, the control circuit 26 turns off the green LED 51 and the red LED 52.

In S190, the control circuit 26 determines whether the trigger switch 8a is turned on or off. If the trigger switch 8a is turned off, the control circuit 26 repeats the determination in S190. If the trigger switch 8a is turned on, the process proceeds to S200.

In S200, likewise S130, the control circuit 26 determines whether the attachment of the rear cover 7 is detected. If the attachment of the rear cover 7 is detected, the control circuit 26 executes normal drive of the motor 10 in S210. Specifically, as mentioned above, the control circuit 26 generates the PWM signal based on the amount of manipulation on the trigger 8 and the rotational speed, and rotates the motor 10.

In S220, the control circuit 26 turns off an alarm. The alarm may be provided by, for example, using the green LED 51 and the red LED 52. In other words, turning off the alarm may mean, for example, turning off the green LED 51 and the red LED 52 together. Blinking the alarm may correspond to, for example, blinking the green LED 51 and the red LED 52 together. Turning on the alarm may correspond to, for example, turning on the green LED 51 and the red LED 52 together. Alternatively, an alarm different from the aforementioned alarm may be provided separately.

If the attachment of the rear cover 7 is not detected in S200, the process proceeds to S230. In S230, the control circuit 26 determines whether the cancel flag is set to ON. If the cancel flag is set to ON, the control circuit 26 executes low speed drive of the motor in S240. More specifically, the control circuit 26 rotates the motor 10 at a speed lower than the speed of the normal drive. In S240, the motor 10 may be stopped. In S250, the control circuit 26 blinks the alarm.

If the cancel flag is set to OFF in S230, the control circuit 26 stops the motor 10 in S260. In S270, the control circuit 26 turns on the alarm

In S280, the control circuit 26 determines whether an auto-stop signal is delivered from the battery pack 3. The battery pack 3 is configured to output the auto-stop signal to the controller 24 in a case where a specific condition, such as over discharge and overheat, is satisfied to stop the discharge from the battery 3a.

If the auto-stop signal is delivered to the control circuit 26 in S280, the control circuit 26 stops the motor 10 in S320. In S330, the control circuit 26 turns on the alarm.

In S340, the control circuit 26 determines whether the trigger switch 8a is turned on or off. If the trigger switch 8a is turned on, the control circuit 26 repeats the determination in S340. If the trigger switch 8a is turned off, the process proceeds to S300.

If the auto-stop signal is not delivered to the control circuit 26 in S280, the control circuit 26 determines, in S290, whether the trigger switch 8a is turned on or off. If the trigger switch 8a is turned on, the process returns to S200. If the trigger switch 8a is turned off, the process proceeds to S300.

In S300, the control circuit 26 stops the motor 10. In S310, the control circuit 26 turns off the alarm. Subsequent to S310, the process proceeds to S190.

### (1-5) Effects of Embodiment

The embodiment explained above exerts the following effects (1a) to (1g).

(1a) In the electric working machine 1 in the present embodiment, each of the various electric circuits (the first to the sixth electric circuits) coupled to the controller 24 is installed by using the traces disposed on the injection-molded members. In other words, a part of each of the various electric circuits is integrally formed on the injection-molded member. This enables efficient installment of the various electric circuits in the electric working machine 1.

More specifically, a work of installing the various electric circuits is made easier for the reason that a work of laying the lead wires is made unnecessary at least for those parts of the various electric circuits disposed on the injection-molded members. Accordingly, a time required for installing the various electric circuits can be reduced.

(1b) Particularly in the first electric circuit including the LED illuminator 41, the first surface circuit 42 is disposed on the inner surface 4a of the half housing 4 that has a three-dimensional shape. In other words, the trace is laid on the surface of such a part that is primarily included in the electric working machine 1. Accordingly, the efficiency of use of the internal space of the housing 2 is further enhanced.

Also in the first electric circuit including the LED illuminator 41, the protruding wall 46 is disposed between the two traces 421, 422 that are disposed on the inner surface 4a of the half housing 4. Accordingly, a chance of short-circuit between the traces 421, 422 can be reduced.

(1c) In the second electric circuit including the green LED 51, the third electric circuit including the red LED 52, and the fourth electric circuit including the USB connector 56, the wirings are laid on the resin wiring member 50. More specifically, the first trace, the second trace, and the third trace are formed on the resin wiring member 50. Moreover, the green LED 51, the red LED 52, and the USB connector 56 are mounted on the resin wiring member 50. Accordingly, the efficiency of installment of the electric circuits including electronic components is further enhanced.

(1d) In the sixth electric circuit including the function to detect whether the rear cover 7 is appropriately attached, the first electrode 31, the second electrode 32, and the connection conductor 33 that electrically couples the first electrode 31 and the second electrode 32 to each other are disposed on the surface of the injection-molded member. This enables an appropriate detection of the attachment of the rear cover 7 while enhancing efficiency of use of the internal space of the housing 2.

(1e) In the fifth electric circuit including the Hall elements 16, 17, 18, the Hall elements 16, 17, 18 are mounted on the insulator 14. A part of the wirings for coupling the Hall elements 16, 17, 18 to the controller 24 is also disposed on the surface of the insulator 14. Although the Hall elements 16, 17, 18 are usually mounted on a circuit board different from the insulator 14, such a circuit board is not required in the present embodiment. Accordingly, efficiency of installment of the electric circuit is enhanced.

(1f) In an operation of assembling the electric working machine 1, various components, wirings, and so forth are assembled inside the housing 2 followed by assembling and screw fastening of the half housings 4, 5. If many lead wires are used inside the housing 2 in the operation of assembling the half housings 4, 5, possibilities of those lead wires being caught between the half housings 4, 5 increases. If the lead wires are caught between the half housings 4, 5, additional work will be required for eliminating the caught lead wires such as pushing the caught lead wires inside the housing 2, which decreases operation efficiency.

In contrast, the electric working machine 1 in the present embodiment does not require the lead wires at least for those parts of the various electric circuits disposed on the injection-molded member; thus the amount of use of the lead wire is reduced accordingly. This can reduce the possibilities for the lead wires to be caught between the half housings 4, 5 in the operation of assembling the half housings 4, 5, and thus enables an efficient assembling.

(1g) The reduction of the amount of use of the lead wires in turn reduces the possibilities of disconnection of the wirings that couple the various electric circuits to the controller 24. More specifically, if the electric working machine 1 vibrates, then wirings with the lead wires may experience, for example, swinging of the lead wires inside the housing 2, abutting of the lead wires against the inner wall of the housing 2, and abutting of the lead wires against each other due to the vibration. The lead wires may consequently be disconnected due to the vibration of the electric working machine 1.

In contrast, in the electric working machine 1 in the present embodiment, possibilities of disconnection due to the vibration are reduced at least for those traces of the various electric circuits disposed on the injection-molded member.

Particularly, disconnections in the traces can be further reduced by inhibiting the traces from contacting other components or other wirings by, for example, disposing the protruding wall between two adjacent traces as shown in FIG. 2, disposing another protruding wall on outer side of each trace in addition to the protruding wall between the traces as shown in FIG. 3, or by disposing a groove on the surface of the injection-molded member and laying the traces in the groove as shown in FIG. 4.

The controller 24 corresponds to one example of the control circuit in the present disclosure. The Hall elements 16, 17, 18 correspond to one example of the rotation position detecting device in the present disclosure. The fifth surface circuit 71, the sixth surface circuit 72, and the seventh surface circuit 73 correspond to one examples of the wiring coupled to the rotation position detecting device in the present disclosure. The first electrode 31 and the second electrode 32 correspond to one example of the conductor in the present disclosure. The rear cover 7 corresponds to one example of the opening attachment in the present disclosure. The connection conductor 33 corresponds to one example of the conductive portion in the present disclosure. The LED illuminator 41, the green LED 51, the red LED 52, the USB connector 56, and the Hall elements 16, 17, 18 correspond to one example of the electronic component in the present disclosure.

### 2. Other Embodiments

The embodiments of the present disclosure have been explained. Nevertheless, the present disclosure should not be limited to the embodiments explained above and may also be achieved in various modifications.

(2-1) The above mentioned embodiments have shown an example to dispose one electric circuit by using one injection-molded member. Nevertheless, one electric circuit may also be disposed by using two or more molded members.

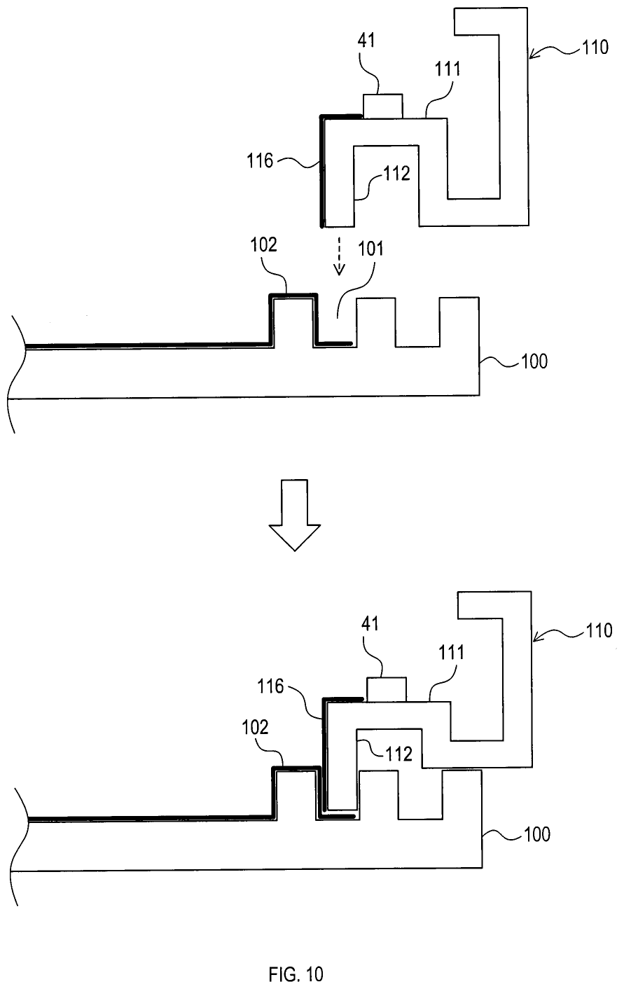

FIG. 10 shows an example in which the LED illuminator 41 is coupled to the controller by using two or more (for example, two) molded members. In this example shown in FIG. 10, the LED illuminator 41 is mounted in an LED case 110. The LED case 110 is a molded member (for example, an injection-molded member) including a mounting face 111, on which the LED illuminator 41 is mounted, and an inset 112. The LED case 110 is molded three-dimensionally in one piece.

On a surface of the LED case 110, a case surface circuit 116 is integrally formed from the mounting face 111 to an end of the inset 112. The case surface circuit 116 includes, for example, two fourth traces coupled to two terminals of the LED illuminator 41. The case surface circuit 116 may be formed by the LDS method for example.

Meanwhile, a recess 101 is provided on an inner surface of a housing 100. The housing 100 is an injection-molded member (for example, an injection-molded member) and corresponds to one example of the first molded member in the present disclosure. The housing 100 is molded three dimensionally in one piece. On the inner surface of the housing 100 including an inner wall of the recess 101, a main body surface circuit 102 is formed integrally. The main body surface circuit 102 includes, for example, two fifth traces. Each of the fifth traces is coupled to the controller 24. The main body surface circuit 102 may be formed by the LDS method for example.

The LED case 110 is attached to the housing 100. More specifically, the inset 112 of the LED case 110 is fit into the recess 101 of the housing 100; thereby, the LED case 110 is fixed to the housing 100.

This fitting of the inset 112 into the recess 101 causes the case surface circuit 116 and the main body surface circuit 102 to contact each other and to be electrically coupled to each other. In this embodiment, for example, each of the fourth traces of the case surface circuit 116 is respectively coupled to the fifth traces of the main body surface circuit 102.

Accordingly, the LED illuminator 41 is fixed to the housing 100 along with the LED case 110, and thus is coupled to the controller 24 via the case surface circuit 116 and the main body surface circuit 102. It is therefore possible to efficiently install the first electric circuit; stably install the electronic component, disposed on the first electric circuit, to the electric working machine 1; and very freely determine an arrangement position of the electronic component in the electric working machine 1.

The LED case 110 corresponds to one example of the second molded member and the component mounted member in the present disclosure. The case surface circuit 116 corresponds to one example of the connection wiring portion in the present disclosure.

The LED case 110 does not have to be an injection-molded member. In other words, the LED case 110 may be molded by a method different from injection molding. Conversely, the LED case 110 may be an injection-molded member, and the housing 100 may be a molded member different from the injection-molded member. In other word, a single electric circuit may be installed by using both an injection-molded member and a molded member made by a method different from that of the injection-molded member.

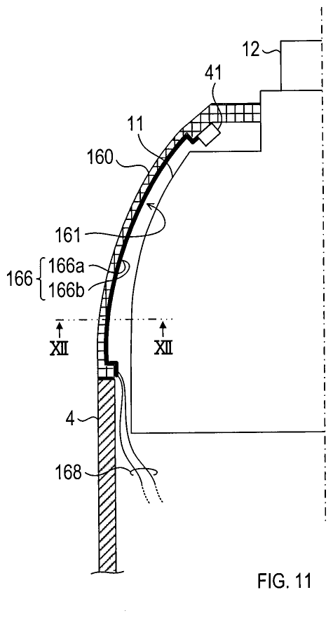

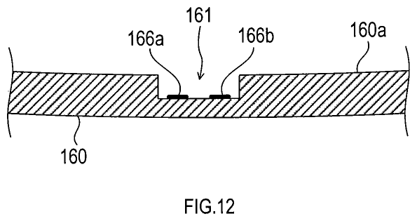

(2-2) The LED illuminator 41 may be disposed at any location. For example, as shown in FIG. 11 and FIG. 12, the LED illuminator 41 may be disposed on an inner surface of a hammer case cover 160. The hammer case cover 160 is a molded member. The hammer case cover 160 may be, for example, an injection-molded member. FIG. 11 shows a part of a cross section of a surface of the electric working machine perpendicular to upper-lower directions of the electric working machine.

In the hammer case cover 160 shown in FIG. 11, the LED illuminator 41 is mounted on a front end of an inner surface 160a of the hammer case cover 160. Additionally, on the inner surface 160a, the surface circuit 166 is integrally disposed towards the rear from the location where the LED illuminator 41 is mounted. The surface circuit 166 includes two traces 166a, 166b which are coupled to the LED illuminator 41.

As shown in FIG. 11 and FIG. 12, a groove 161 is disposed on the inner surface 160a from a vicinity of the location where the LED illuminator 41 is mounted towards a rear end of the inner surface 160a. The surface circuit 166 is disposed through inside the groove 161 to a rear end of the groove 161. The surface circuit 166 may be formed on the hammer case cover 160 by, for example, the LDS method.

A gap between the inner surface 160a and the hammer case 11 is narrow; and thus it is not easy to place the lead wire through this gap. Nevertheless, as shown in FIG. 11 and FIG. 12, wiring using the surface circuit 166 enables the LED illuminator 41 to be disposed in the front end of the hammer case cover 160.

The groove 161 is disposed on the hammer case cover 160, and the surface circuit 166 is disposed in this groove 161. Accordingly, it is possible to easily and appropriately apply insulation coatings, desiccants, and the like on the surface circuit 166 inside the groove 161.

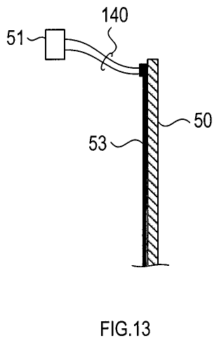

(2-3) The electronic component does not have to be mounted in a molded member. For example, as shown in FIG. 13, the green LED 51 does not have to be mounted in the resin wiring member 50 and may be disposed at a location away from the resin wiring member 50. In this case, the green LED 51 and the second surface circuit 53 may be coupled to each other via a harness 140. The harness 140 may include two lead wires for example.

Such a combined use of the surface circuit, disposed in the molded member, and the lead wires allows very free determination of the arrangement position of the electronic component while enhancing efficient installment of the electric circuit.

(2-4) If the controller case is a molded member, a part of the electric circuit such as a trace may be formed on a surface of the controller case by, for example, the LDS method.

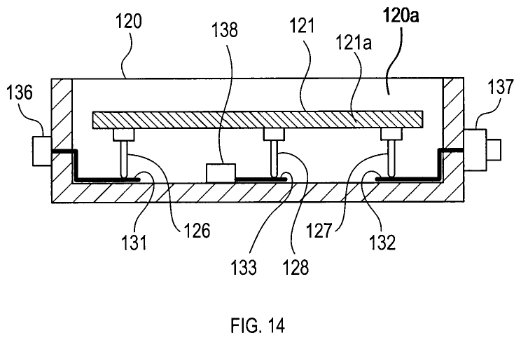

A controller case 120 shown in FIG. 14 is a molded member (for example, an injection-molded member). The controller case 120 is formed three dimensionally in one piece. A housing space 120a is disposed inside the controller case 120. The housing space 120a houses a controller 121. The controller 121 includes a board 121a. The controller 121 may be partially or entirely configured in the same manner as the controller 24 shown in FIG. 7.

On an inner wall of the controller case 120 facing the housing space 120a, for example, three surface circuits 131, 132, 133 are integrally disposed. Also on the inner wall, for example, a single electronic component 138 is mounted. The electronic component 138 is coupled to the surface circuit 133.

On an outer side surface of the controller case 120, for example, an LED 136 and a switch 137 are mounted. The surface circuit 131 is disposed through the inner wall to be coupled to the LED 136. The surface circuit 132 is disposed through the inner wall to be coupled to the switch 137.

The controller 121 includes, for example, three metal terminals 126, 127, 128 protruding from the controller 121. A leading end of the metal terminal 126 contacts the surface circuit 131; a leading end of the metal terminal 127 contacts the surface circuit 132; and a leading end of the metal terminal 128 contacts the surface circuit 133.

According to such a configuration, the LED 136 is coupled to the controller 121 via the surface circuit 131 and the metal terminal 126; The switch 137 is coupled to the controller 121 via the surface circuit 132 and the metal terminal 127; and the electronic component 138 is coupled to the controller 121 via the surface circuit 133 and the metal terminal 128. Each of the surface circuits 131, 132, 133 includes, for example, two or more traces.

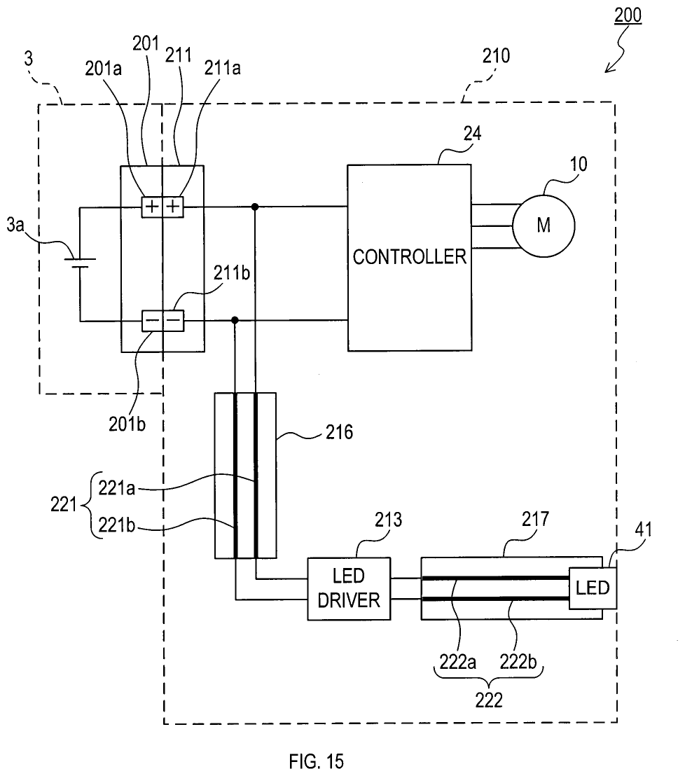

(2-5) The electric circuit in the present disclosure may be different from those that operates in response to a supply of electric power from the control circuit, or from those whose operation is controlled by the control circuit. In other words, the electric circuit may be configured to operate independently from the control circuit albeit being electrically coupled to the control circuit. FIG. 15 shows one example of the electric working machine including an electric circuit that operates independently from the control circuit.

The electric working machine 200 shown in FIG. 15 includes a housing 210 and a battery pack 3. The battery pack 3 is the same as the battery pack 3 shown in FIG. 1 and includes the battery 3a. The battery pack 3 also includes a terminal block 201. The terminal block 201 includes a positive terminal 201a and a negative terminal 201b. The positive terminal 201a is coupled to a positive electrode of the battery 3a; and the negative terminal 201b is coupled to a negative electrode of the battery 3a.

The housing 210 is configured basically in the same manner as the housing 2 shown in FIG. 1. The housing 210 include thereinside the motor 10, the controller 24, various components including the LED illuminator 41, wirings, and the like.

The housing 210 also includes a terminal block 211. The terminal block 211 includes a positive terminal 211a and a negative terminal 211b. The positive terminal 211a and the negative terminal 211b are coupled to the controller 24.

In response to an attachment of the battery pack 3 to the housing 210, the positive terminal 201a of the battery pack 3 is coupled to the positive terminal 211a of the housing 210; the negative terminal 201b of the battery pack 3 is coupled to the negative terminal 211b of the housing 210. Electric power is accordingly supplied from the battery 3a to the controller 24.

The housing 210 further includes an LED driver 213, a first resin wiring member 216, and a second resin wiring member 217. The first resin wiring member 216 and the second resin wiring member 217 are both resin-molded members (for example, injection-molded members).

The LED driver 213 is electrically coupled to the LED illuminator 41. The LED driver 213 is also electrically coupled to the positive terminal 211a and the negative terminal 211b. The LED driver 213 drives the LED illuminator 41.

An electric circuit for supplying electric power from the battery 3a to the LED driver 213 is laid between the positive terminal 211a and the LED driver 213 as well as between the negative terminal 211b and the LED driver 213. This electric circuit includes a surface circuit 221. The surface circuit 221 is integrally formed on a surface of the first resin wiring member 216 by, for example, the LDS method. The surface circuit 221 includes a first trace 221a and a second trace 221b. The first trace 221a is coupled to the positive terminal 211a; and the second trace 221b is coupled to the negative terminal 211b.

The LED driver 213 drives the LED illuminator 41 by the electric power supplied from the battery 3a. An electric circuit for supplying electric power from the LED driver 213 to the LED illuminator 41 is laid between the LED driver 213 and the LED illuminator 41. This electric circuit includes a surface circuit 222. The surface circuit 222 is integrally formed on a surface of the second resin wiring member 217 by, for example, the LDS method. The surface circuit 222 includes a first trace 222a and a second trace 222b.

The LED illuminator 41 may be directly mounted on the second resin wiring member 217, or disposed separately from the second resin wiring member 217 and coupled to the surface circuit 222 via a lead wire for example.

At least one of the first resin wiring member 216 or the second resin wiring member 217 may be the housing 210. In other words, at least one of the surface circuits 221 or 222 may be disposed on a surface of the housing 210.

The surface circuit 221 and the terminal block 211 may be electrically coupled to each other in any manner. For example, the surface circuit 221 and the terminal block 211 may be coupled to each other via a lead wire. Alternatively, the surface circuit 221 may be coupled to an unillustrated terminal for supplying battery power disposed in the controller 24 via a lead wire for example. Alternatively, for example, a lead wire may be used for wiring from a given point on a wiring that couples the terminal block 211 to the controller 24 to the surface circuit 221.

The LED driver 213 may be installed on a surface of the first resin wiring member 216 or of the second resin wiring member 217. The first resin wiring member 216, the LED driver 213, and the second resin wiring member 217 may all be disposed on the same single resin-molded member.

Either one of the first resin wiring member 216 or the second resin wiring member 217 does not have to be disposed. For example, while the first resin wiring member 216 is disposed, the LED driver 213 and the LED illuminator 41 may be coupled to each other, for example, via a lead wire without using the surface circuit 222.

In addition to the electric circuit including the LED illuminator 41 and the LED driver 213 as shown in FIG. 15, if a different electric circuit that is electrically coupled to the controller 24 but operates independently from the controller 24, then the present disclosure can be applied also to such an electric circuit.

(2-6) The electric circuit may include an electronic component other than those described in the aforementioned embodiments (such as LEDs, connectors, and Hall elements). The electronic component may be, for example, an active element of various kinds, such as a transistor and a diode. The electronic component may also be, for example, a passive element of various kinds, such as a resistor, a capacitor, and a coil. The electronic component may also be a component of various kinds, such as an illuminating device other than LEDs, a connector other than USB connectors, a display device, a switch, a fuse, an electric wire, a circuit board, an integrated circuit, and an antenna.

(2-7) The method of detecting an attachment of the rear cover 7 using the surface circuit, which was explained with reference to FIG. 5, may also be used for detecting an attachment of a component other than the rear cover 7. For example, the same method as the method of detecting an attachment of the rear cover 7 in the aforementioned embodiment may be used to detect whether a dust collection hose is attached to a dust collecting opening of a dust collector.

(2-8) The motor may be those other than the brushless motor. The motor may be, for example, a direct-current brushed motor. In case of using a motor other than the brushless motor, a drive circuit that is configured to appropriately drive such a motor may be used.

(2-9) Among the housing 2, the resin wiring member 50, the insulator 14, the rear cover 7; the LED case 110 and the housing 100 in FIG. 10; the hammer case cover 160 in FIG. 11; the controller case 120 in FIG. 14; and the housing 210, the first resin wiring member 216, and the second resin wiring member 217 in FIG. 15 in the aforementioned embodiments, at least one (hereinafter referred to as surface wiring base material) may be the injection-molded member as mentioned earlier or may be the molded member different from the injection-molded member, in other words, the molded member formed by a method different from the injection molding (for example, blow molding, extrusion molding, compression molding, low temperature and pressure molding, or the like). The surface wiring base material does not have to be an integrally molded item.

The surface wiring base material may include any insulating material. The surface wiring base material may include a resin, for example, a thermoplastic resin or a thermosetting resin. The surface wiring base material may include an insulating material different from resins (for example, glasses and rubbers). The surface wiring base material may be a molded member including a mixture of a resin and an insulating material different from resins.

The whole of the surface wiring base material may be an insulating material; or the surface wiring base material may include an insulating material and a material different from the insulating material. The surface wiring base material may include a mixture of an integrally molded part, formed by molding methods such as injection molding, and other part formed by a method different from integral molding methods. For example, in a case where the surface wiring base material includes an insulating material and a material different from the insulating material, the whole of the insulating material may be integrally molded by, for example, injection molding and the material different from the insulating material may be formed by a method different from integral molding.

(2-10) In each of the aforementioned embodiments, a rechargeable impact driver was shown as one example of the electric working machine. The present disclosure can nevertheless be applied to varieties of electric working machine that includes a motor and a control circuit for controlling the motor. More specifically, the present disclosure may be applied to electric working machines, such as electric hammers, electric hammer drills, electric drills, electric drivers, electric wrenches, electric grinders, electric reciprocating saws, electric jigsaws, electric cutters, electric chain saws, electric planers, electric nail guns (including tackers), electric hedge trimmers, electric lawn mowers, electric grass trimmers, electric grass cutters, electric cleaners, and electric blowers.

(2-11) Two or more functions achieved by one element in the aforementioned embodiments may be achieved by two or more elements. One function achieved by one element in the aforementioned embodiments may be achieved by two or more elements. Two or more functions achieved by two or more elements in the aforementioned embodiments may be achieved by one element; one function achieved by two or more elements in the aforementioned embodiments may be achieved by one element. A part of the configuration of the aforementioned embodiments may be omitted. At least a part of the configuration of any one of the aforementioned embodiments may be added to or replaced with another one of the aforementioned embodiments.

1-20. (canceled)

21. An electric working machine comprising:
a housing including an inner surface therein, the housing including a rear end surface with a rear opening;
a rear cover configured to cover the rear opening, the rear cover being configured to be detachably attached to the rear end surface;
a trigger disposed in the housing, the trigger being configured to be manipulated by a user of the electric working machine;
a brushless motor housed in the housing;
a chuck sleeve protruding from the housing, the chuck sleeve being configured to attach a tool bit thereto, and the chuck sleeve being configured to rotate by a rotational driving force of the brushless motor;
a controller housed in the housing;
a resin wiring member housed in the housing, the resin wiring member including an insulating material, the resin wiring member being molded in one piece, and the resin wiring member including a surface with a three dimensionally shaped portion;
an insulator fixed to the brushless motor, the insulator including an insulating material, the insulating material including a resin, the insulator including a surface, and the insulator being formed three dimensionally in one piece;
an LED illuminator housed in the housing;
a first LED, a second LED, and a connector mounted on the surface of the resin wiring member;
a Hall element mounted on the surface of the insulator;
a first surface circuit electrically coupling the LED illuminator to the controller, the first surface circuit being provided on the inner surface of the housing, and the first surface circuit including a first trace and a second trace;
a second surface circuit electrically coupling the first LED to the controller, the second surface circuit being integrated with the resin wiring member on the surface of the resin wiring member;
a third surface circuit electrically coupling the second LED to the controller, the third surface circuit being integrated with the resin wiring member on the surface of the resin wiring member;
a fourth surface circuit electrically coupling the connector to the controller, the fourth surface circuit being integrated with the resin wiring member on the surface of the resin wiring member;
a fifth surface circuit electrically coupling the Hall element to the controller, the fifth surface circuit being integrated with the insulator on the surface of the insulator;
a protruding wall standing on the inner surface between the first trace and the second trace;
a first electrode integrated with the rear end surface of the housing, the first electrode being electrically coupled to the controller;
a second electrode integrated with the rear end surface, the second electrode being electrically coupled to the controller; and
a connection conductor disposed on the rear cover, the connection conductor being configured to come into contact with the first electrode and the second electrode in response to the rear cover being attached to the rear end surface, the connection conductor being configured to electrically couple the first electrode and the second electrode to each other via the connection conductor in response to the connection conductor being in the contact with the first electrode and the second electrode.

22. An electric working machine comprising:
a first molded member including an insulating material and being molded in one piece;
a motor;
a control circuit configured to control the motor; and
an electric circuit coupled to the control circuit and including a surface circuit that is integrally arranged on a surface of the first molded member.

23. The electric working machine according to claim 22, wherein
the surface of the first molded member includes a three dimensionally shaped portion; and
at least a part of the surface circuit is located on the three dimensionally shaped portion.

24. The electric working machine according to claim 22, wherein the electric circuit includes:
an electronic component provided separately from the surface circuit; and
a lead wire coupling the electronic component to the surface circuit.

25. The electric working machine according to claim 22, wherein
the electric circuit includes an electronic component, the electronic component being disposed on the first molded member, and the electronic component being coupled to the surface circuit.

26. The electric working machine according to claim 22, further comprising a component mounted member arranged so as to contact the surface circuit, wherein
the electric circuit includes:
an electronic component disposed in the component mounted member; and
a connection wiring portion disposed on a surface of the component mounted member so as to contact the surface circuit and configured to couple the electronic component to the surface circuit.

27. The electric working machine according to claim 26, wherein
the first molded member includes a recess including an inner wall;
a part of the surface circuit is located on the inner wall;
the component mounted member includes an inset configured to fit into the recess; and
a part of the connection wiring portion is located on the inset.

28. The electric working machine according to claim 26, further comprising a second molded member including an insulating material and being molded in one piece, wherein
the second molded member includes the component mounted member.

29. The electric working machine according to claim 24, wherein
the electronic component includes a light emitting element configured to emit light.

30. The electric working machine according to claim 24, wherein
the electronic component includes a connector configured to be coupled to a connector situated externally of the electric working machine.

31. The electric working machine according to claim 25, wherein the motor is a brushless motor including a permanent-magnet type rotor;
the first molded member is placed in a fixed position relative to the brushless motor;
the electronic component includes a rotation position detecting device configured to output a signal associated with a rotation position of the rotor; and
the surface circuit includes a wiring coupled to the rotation position detecting device.

32. The electric working machine according to claim 22, further comprising a housing that houses the motor, the control circuit, and the electric circuit, wherein
the first molded member is a separate member from the housing and is disposed inside the housing.

33. The electric working machine according to claim 32, wherein
the first molded member includes a case member including a housing space for housing the control circuit; and
the surface circuit is disposed on an inner wall of the case member facing the housing space.

34. The electric working machine according to claim 22, wherein
the first molded member includes a housing that houses the motor, the control circuit, and the electric circuit.

35. The electric working machine according to claim 22, wherein
the first molded member include an opening exposed externally from the electric working machine; and
the electric working machine further includes an opening attachment attached to the opening.

36. The electric working machine according to claim 35, wherein
the opening attachment is configured to be removable from the opening;
the surface circuit includes two conductors disposed at the opening separately from each other; and
the opening attachment includes a conductive portion configured to be coupled to the two conductors and electrically couple the two conductors to each other in response to the opening attachment being attached to the opening.

37. The electric working machine according to claim 35, wherein
the first molded member includes a housing, which houses the motor, the control circuit, and the electric circuit and includes the opening; and
the opening attachment is configured to cover the opening.

38. The electric working machine according to claim 22, wherein
the surface circuit includes two wirings disposed along a given wiring path; and
the first molded member includes a protruding wall standing between the two wirings and extending along the given wiring path.

39. The electric working machine according to claim 22, wherein
the first molded member includes an injection-molded member.

40. A method of building an electric system in an electric working machine, the method comprising:
disposing a control circuit in the electric working machine, the control circuit being configured to control a motor;
disposing a molded member in the electric working machine, the molded member including an insulating material and being molded in one piece, and the molded member having a surface with a surface circuit integrally arranged thereon; and
coupling the surface circuit and the control circuit to each other.

41. A method of building an electric system in an electric working machine, the method comprising:
disposing a control circuit in the electric working machine, the control circuit being configured to control a motor; and
disposing a molded member in the electric working machine, the molded member including an insulating material and being molded in one piece, the molded member having a surface with a surface circuit integrally arranged thereon, and the surface circuit being coupled to or being configured to be coupled to the control circuit.
